(19) United States
(12) Patent Application Publication
(10) Pub. No.: US 2004/0193919 A1
(43) Pub. Date: Sep. 30, 2004

(54) Method and apparatus for identifying trusted devices

(76) Inventors: Ezzat A. Dabbish, Cary, IL (US); Douglas A. Kuhlman, Elgin, IL (US); thomas S. Messerges, Schaumburg, IL (US)

Correspondence Address: MOTOROLA, INC., 1303 EAST ALGONQUIN ROAD, IL01/3RD, SCHAUMBURG, IL, 60196

(21) Appl. No.: 10/403,304

(22) Filed: Mar. 31, 2003

(51) Int. Cl. H04L 9/00; G06F 7/00

(52) U.S. Cl. 713/201; 707/9

(57) ABSTRACT

To address the need for a communicating electronic device (102) to identify other trusted devices (103) and allow for applications, such as digital-rights management, and the easy transfer of content and commands (217) among devices, a method and apparatus for identifying trusted devices (103) is disclosed herein. Each electronic device wishing to share digital content will comprise a database (209) containing a list of trusted and/or non-trusted devices. The list of trusted and non-trusted devices is similar to a master list of trusted and non-trusted devices that exists at the certificate authority or an equivalent trusted server. However, in order to limit the size of the database existing on the electronic device, only a portion of the master list will be stored locally.

### FIELD OF THE INVENTION

The present invention relates generally to authentication and in particular, to a method and apparatus for identifying trusted devices.

### BACKGROUND OF THE INVENTION

Electronic devices equipped with microprocessors and communication capabilities are becoming more widespread and many new applications are being developed for these devices. As these communicating devices become more ubiquitous, users need to trust them to act and communicate with other devices in a certain manner. These devices are being used in many situations. Communicating electronic devices are being used to handle digital content such as music, games, video clips, books; sensitive private data, such as medical records, financial data, credit card numbers; and security and safety situations, such as industrial controls, building automation, security alarms, etc.

In many situations, the digital content, information, and commands, communicated by these devices needs to be protected at all times. For example, content owners require content rendering devices to be trusted to protect their copyrights. Digital content has an intrinsic value and content owners require that protection means be used to ensure that they are fairly compensated for the use of their assets. Digital Rights Management (DRM) is a technology used to protect rights and manage usage rules related to accessing and processing digital content. Content owners hope to protect their valuable digital content using DRM that is implemented by secure, tamper-resistant electronic devices, such as cellular phones. Because content typically comprises digital bits instead of a physical CD, tape, book, etc., the move to digital content represents a paradigm shift for users in the way they acquire, handle, render, and utilize their content. Despite this, users would like to continue doing things with digital content that were typically done with physical content, such as loaning their “digital” content to a friend, carrying music to a friend's house for rendering, playing content on their stereo system, etc.

The content that needs protection could take many forms. For example, the content could be private information such as medical records, financial data, or credit card numbers. For example, individuals may choose to keep their medical records on electronic devices such as a smart card, or they may choose to keep credit card information on their mobile phone. Again, the information stored on these devices is useful only if it can be sometimes transferred to other devices; such as when a user is involved in a medical emergency or when he decides to make a credit card purchase. The content could also be a person's software agent that wishes to engage in a transaction on another device, such as purchasing airline tickets, bidding in an auction, negotiating a meeting, etc. Finally, the content that needs protection could also be comprised of commands, such as in a building automation situation where a command to shut off the lights, engage the alarm system, lock the doors, etc. is communicated.

One thing that all of these scenarios have in common is that digital content or commands are being transported/transferred from one device to another. This transfer of content between two devices is via a peer-to-peer network and requires that content be protected at all times. This means that devices in the peer-to-peer network will need to be trusted to enforce usage rules and, to not compromise the digital content. When content or commands are transported to a peer device, there is a need to also establish the trustworthiness of the receiving device.

Typically, there are several approaches for a device to identify whether another device can be trusted. For example, devices may be assigned digital certificates that are signed by a Central Authority (CA) or equivalent trusted server. A device wishing to determine if another device can be trusted can do so by verifying that device's certificate. One potential problem is that a device may be initially trustworthy (i.e., the CA signed the device's certificate), but at some later date, the device may become compromised (e.g., by a hacker). A compromised device no longer can be trusted, so prior-art solutions solve this problem in a few ways. One way is that the CA maintains a server with a large database of all devices that have become compromised. Devices that have had their trustworthiness revoked are added to this large database, which is often called a “revocation list”.

When a first device wishes to identify whether a second device is trustworthy, the first device can query the CA server's database to see if the second device's certificate has been revoked (i.e., the second device is on the revocation list). An example of this “server-based approach” is given in U.S. Pat. No. 6,398,245, KEY MANAGEMENT SYSTEM FOR DIGITAL CONTENT PLAYER. In some cases, contacting a single server for obtaining access to the revocation list becomes a bottleneck in the system. When too many requests are made to a single server, prior-art solutions allow the revocation list to be copied to local servers, thus alleviating the bottleneck. Another solution to the revocation problem is to create certificates that are valid for only a brief period of time. This technique is described in detail in U.S. Pat. No. 6,463,534 SECURE WIRELESS-ELECTRONIC COMMERCE SYSTEM WITH WIRELESS NETWORK DOMAIN. In the case of short-lived certificate, devices will need to periodically communicate with the CA to obtain fresh and valid certificates. The CA will only issue new certificates to devices that are not revoked. So, by using expiring certificates identification of compromised devices will be possible.

All of these prior art solutions (i.e., a server-based revocation list, a local-based revocation list, or expiring certificates), however, have drawbacks. In the case of portable devices, a trusted server can ensure security, however such a server is not always available. Also, a server-based approach would not be very efficient in the case where two devices are using a local network to communicate. In the case of a local-based revocation list, small portable devices may not have enough memory to store an entire revocation list. For example, there are many millions of cellular phones in the world. If only a small percentage of these phones were revoked, the revocation list becomes quite large. It is very expensive to equip small portable devices with enough memory to store such large lists. Finally, expiring certificates also do not provide an ideal solution. Expiration or validity dates require that a device continually obtain a new certificate and that devices checking these certificates have a secure source of time and date information. Simple devices, such as wireless headsets (e.g., for portable music players) or home audio equipment may not be able to renew their certificates and also may not have access to a trusted time source. Therefore, a need exists for a method and apparatus for identifying a trusted device that eliminates the shortcomings of prior-art techniques.

### BRIEF DESCRIPTION OF THE DRAWINGS

FIG. 1 is a block diagram of a communication system with trust identification capabilities in accordance with the preferred embodiment of the present invention.

FIG. 2 is a more-detailed block diagram of the communication system of FIG. 1 in accordance with the preferred embodiment of the present invention.

FIG. 3 is a block diagram of a digital-rights management system using a communication system with trust identification capabilities in accordance with the preferred embodiment of the present invention.

FIG. 4 is a block diagram of a medical monitoring system using a communication system with trust identification capabilities in accordance with the preferred embodiment of the present invention.

FIG. 5 is a block diagram of a building automation system using a communication system with trust identification capabilities in accordance with the preferred embodiment of the present invention.

FIG. 6 is a flow chart showing operation of an electronic device in accordance with the preferred embodiment of the present invention.

FIG. 7 is a flow chart showing operation of a certificate authority in accordance with the preferred embodiment of the present invention.

### DETAILED DESCRIPTION OF THE DRAWINGS

To address the need for a communicating electronic device to identify other trusted devices and allow for applications, such as digital-rights management, and the easy transfer of content and commands among devices, a method and apparatus for identifying trusted devices is disclosed herein. In accordance with the preferred embodiment of the present invention, each electronic device wishing to share digital content will comprise a database containing a list of trusted and/or non-trusted devices. The list of trusted and non-trusted devices is similar to a master list of trusted and non-trusted devices that exists at the certificate authority or an equivalent trusted server. However, in order to limit the size of the database existing on the electronic device, only a portion of the master list will be stored locally.

Several techniques are provided for limiting the size of the local database. For example, a means for limiting the size of the database is provided that limits the size of the local database to other devices recently encountered. In another embodiment the size of the local database is limited to devices most frequently encountered. In yet another embodiment of the present invention the size of the database is limited to contain those devices designated by the user.

Because a database of trusted devices exists locally to each device wishing to transfer content, the need to contact a remote server (e.g., content authority) is greatly reduced. Therefore, in many situations, even when the certificate authority is unavailable, a user's electronic device can still establish trust between different devices.

The present invention encompasses an apparatus comprising digital content or a digital command, means for transferring the digital content or the digital command to another device, and a database coupled to the means for transferring. In the preferred embodiment of the present invention the database comprises only a portion of a second database existing on a remote server, and includes a list of trusted and/or non-trusted devices.

The present invention additionally encompasses a method comprising the steps of determining that a digital command or digital content needs to be transferred from a first device to a second device, and determining if the second device exists within an internal database. The internal database comprises only a portion of a second database existing on a remote server, and includes a list of trusted and/or non-trusted devices. The digital command or digital content is transferred to the second device based on the determination if the second device exists within the internal database.

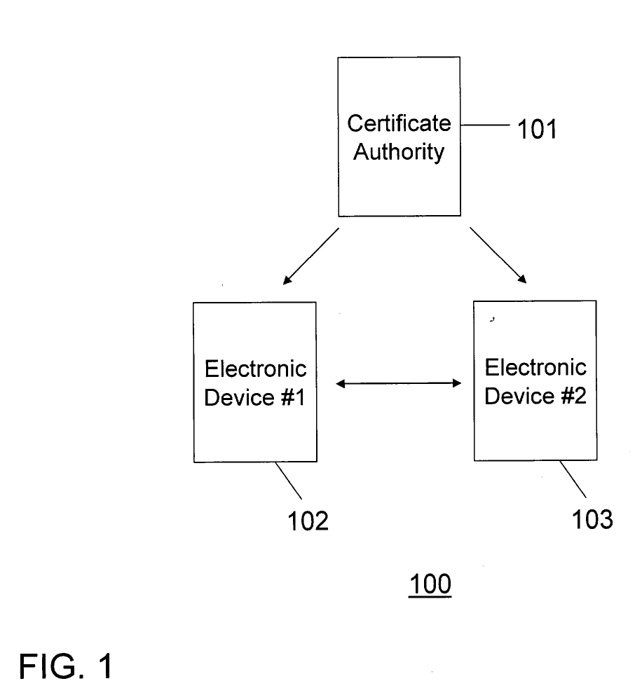

Turning now to the drawings, wherein like numerals designate like components, FIG. 1 is a block diagram of a communication system 100 with trust identification capabilities in accordance with the preferred embodiment of the present invention. As shown, communication system 100 comprises certificate authority, or equivalent trusted server 101, electronic device 102, and electronic device 103. The main purpose of the certificate authority 101 is to provide a trust mechanism to verify the trustworthiness of devices receiving/transferring digital content or commands in the system. In doing so, certificate authority 101 can use a system based on public-key cryptography, whereby a root public and private key-pair (KrPub and KrPri, respectively) are maintained. Users of the system and content owners trust certificate authority 101 to certify only legitimate electronic devices. Certificate authority 101 certifies these legitimate devices by issuing certificates signed with its private key KrPri. As long as KrPri is protected and solely under the control of certificate authority 101, devices within system 100 will trust that certificate authority 101 must have created any certificate signed with KrPri. Certificate authority 101 also maintains a revocation master list that contains the identity of all electronic devices that are known to be compromised, or non-trusted.

In accordance with the preferred embodiment of the present invention electronic device 102 comprises any device capable of storing and transferring digital content or sending commands. Examples of such devices include Personal Digital Assistants (PDAs), cellular telephones, portable music players (e.g., MP3), medical monitoring systems, remote control devices, . . . , etc. In accordance with the preferred embodiment of the present invention electronic device 102 is capable of transferring digital content or commands to any electronic device 103. Typical methods for transferring digital content or commands include, but are not limited to using a wireless connection (e.g., Bluetooth, IEEE 802.11, CDMA, etc.) or a wired connection (e.g., Universal Serial Bus).

As discussed above, when content is transported between devices, there is a need to also establish the trustworthiness of the receiving device. For example, if electronic device 102 had a desire to transfer digital content to electronic device 103, the trustworthiness of electronic device 103 should be verified prior to making the transfer. This is needed in order to ensure that the receiving device 103 does not perform illegal operations on the protected content. For example, a compromised (broken) device might copy the unprotected digital content for distribution on the Internet or, less severely, give false information about the number of copies made or times the content has been accessed.

As discussed above, prior art techniques for assuring the trustworthiness of devices usually comprised accessing a trusted server to access a database containing trusted/non-trusted devices. Although the prior art method for assuring trustworthiness is adequate, a server-based approach would not be very efficient in the case where two devices have intermittent access to the server or when two devices are communicating frequently. In order to address this issue, in the preferred embodiment of the present invention an electronic device wishing to identify the trustworthiness of another electronic device will comprise an internal database containing trusted/non-trusted devices. The list of trusted and non-trusted devices is similar to a master list of trusted and non-trusted devices that exists at the certificate authority 101. However, in order to limit the size of the database existing on electronic device 102, only a portion of the master list will be stored locally.

There are several techniques utilized to limit the size of the internal database. In a first embodiment, device 102 periodically updates the internal database by accessing a remote database on a periodic basis to retrieve status information for other devices recently encountered. In another embodiment device 102 periodically updates the internal database by accessing a remote database on a periodic basis to retrieve status information for those devices designated by a user. Finally, in another embodiment device 102 periodically updates the internal database by accessing a remote database on a periodic basis to retrieve status information for those devices most recently encountered.

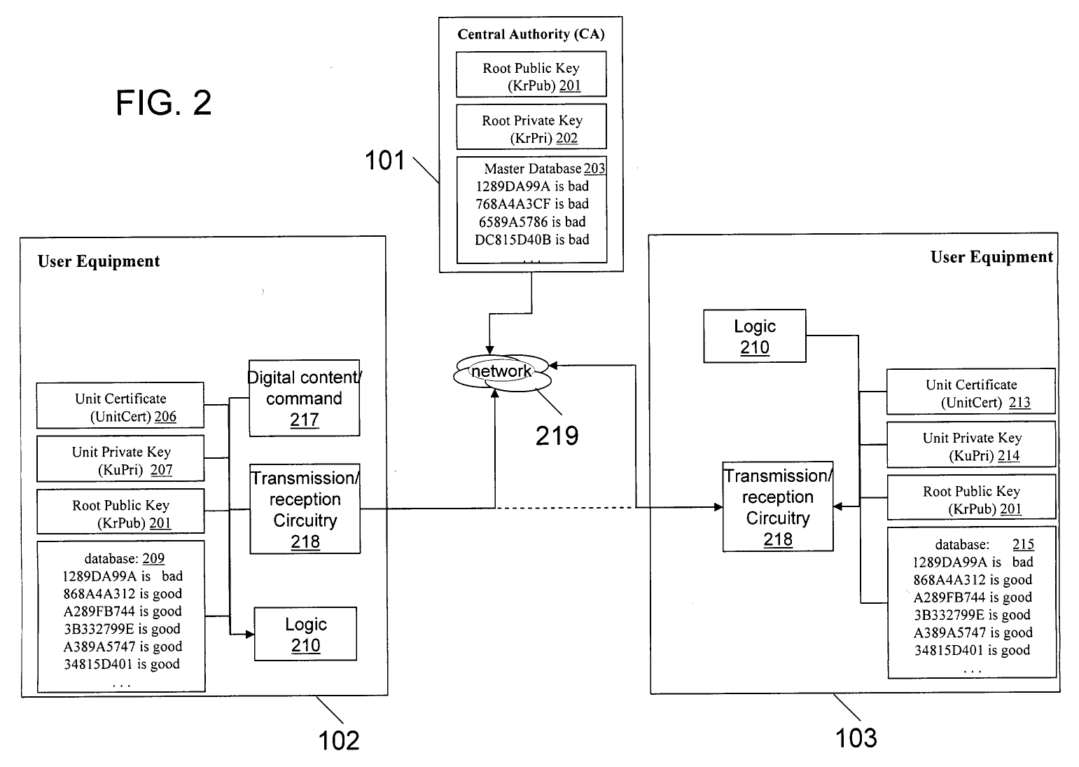

FIG. 2 is a more detailed block diagram of communication system 100 in accordance with the preferred embodiment of the present invention. For illustration, FIG. 2 shows content transfer from electronic device 102 to device 103; however, one of ordinary skill in the art will recognize that content transfer may just as easily occur from device 103 to device 102. Also, independent of the direction of the content transfer, one of ordinary skill in the art will recognize that trust can be established in various directions. For example, electronic device 102 may wish to determine the trustworthiness of electronic device 103, electronic device 103 may wish to determine the trustworthiness of electronic device 102, or both devices might wish to determine the trustworthiness of each other. Both electronic device 102 and 103 contain logic circuitry 210, which preferably is a microprocessor controller such as, but not limited to an ARM-9, ARM-11 or M*core processor available from semiconductor manufacturers, such as Motorola, Inc. As shown, electronic devices 102, 103 also contains the following enabling elements: unit certificate (UnitCert) 206, 213, unit private key (KuPri) 207, 214, and root public key (KrPub) 201.

Unit private keys 207 and 214 are part of a public/private key pair that is used by the electronic device when authenticating to a content provider or another device. The unit certificates 206 and 213 are signed by central authority 101 (using root private key KrPri 202) and contain the electronic device's unit public key information (i.e., the public key that is paired with the unit private key KuPri). Electronic devices also have a root public key KrPub 201 that is used to verify certificates signed by central authority 101. The acquisition of digital content 217 is known in the art and described, for example, in U.S. Pat. No. 6,427,140, SYSTEMS AND METHODS FOR SECURE TRANSACTION MANAGEMENT AND ELECTRONIC RIGHTS PROTECTION. One of ordinary skill in the art will recognize that other methods of establishing a secure identity of an electronic device are also possible. For example, public keys could be chained, whereby a series of public-key certificates are sequentially verified ending at the root public key KrPub 201. Another possibility is that a device is identified by a tamper-resistant serial number. The essential assumption in the preferred embodiment of the present invention is that a device can be uniquely identified using a technique, whereby the identity of the device can be traced using a database.

As discussed above, in order to help determine if another device is trusted or non-trusted, an external database (e.g., central authority 101) comprises master database 203 of all trusted/non-trusted devices. In accordance with the preferred embodiment of the present invention each electronic device 102, 103 also comprises cached databases 209, 215 that are subsets of database 203. During operation, logic circuitry 210 acts as means for limiting a size of internal databases by periodically accessing central authority 101 and acquiring only a subset of database 203 for internal storage. In the preferred embodiment of the present invention the accessing of central authority 101 is periodic (e.g., once per day) in order to assure the freshness of data existing within cached databases 209 and 215. However, in alternate embodiments of the present invention, the updating of cached, or internal databases 209 and 215 may take place when other criteria are met. For example, local databases 209 and 215 can be updated every time a new device is encountered, every time communication with a new device is required, every time a command is sent to a new device, every time private or protected content is sent to a new device, or every time a server is in range when the processor is idle. Regardless of the method for updating internal databases 209 and 215, the rules for doing so are stored internal to devices 102 and 103 and are executed by logic circuitry 210.

Because of the number of devices that can access central authority 101, master database 203 may be quite large. In order to reduce the size of cached databases 209 and 215, logic circuitry 210 serves as means to limit the size of the databases. In the preferred embodiment of the present invention the size of the databases is limited to devices most recently encountered, however in alternate embodiments of the present invention logic circuitry 210 may use other techniques for limiting the size of cached databases 209 and 215. For example, logic circuitry 210 may limit the size of the databases by performing any one, or a combination of the following: including those devices most recently encountered, including those devices most frequently encountered, or including those devices designated by a user. Regardless of the techniques utilized to limit the size of cached databases 209 and 215, in the preferred embodiment of the present invention cached databases 209 and 215 comprise a subset of master database 203.

When content 217 is desired to be transferred between devices (e.g., from electronic device 102 to electronic device 103), logic circuitry 210 checks internal cached database 209 to determine the status of electronic device 103 (e.g., trusted/non-trusted). If it is determined that electronic device 103 is trusted, the transfer is allowed to take place. However, if it is determined that electronic device 103 is non-trusted, the transfer is halted by logic circuitry 210. It should be noted that if electronic device 103 does not exist on cached database 209, logic circuitry 210 will attempt to access master database 203 to determine the status of electronic device 103. If electronic device 103 has been identified as trustworthy, file sharing procedures take place. For example, electronic device 102 can stream digital content 217 to electronic device 103. Electronic device 103 will be trusted to properly handle the received content. It should be noted that means for transmitting and receiving information/digital content takes place via utilization of transmission/reception circuitry 218. Such digital content/information may be transmitted over network 219, or simply transmitted in a peer-to-peer fashion directly between devices.

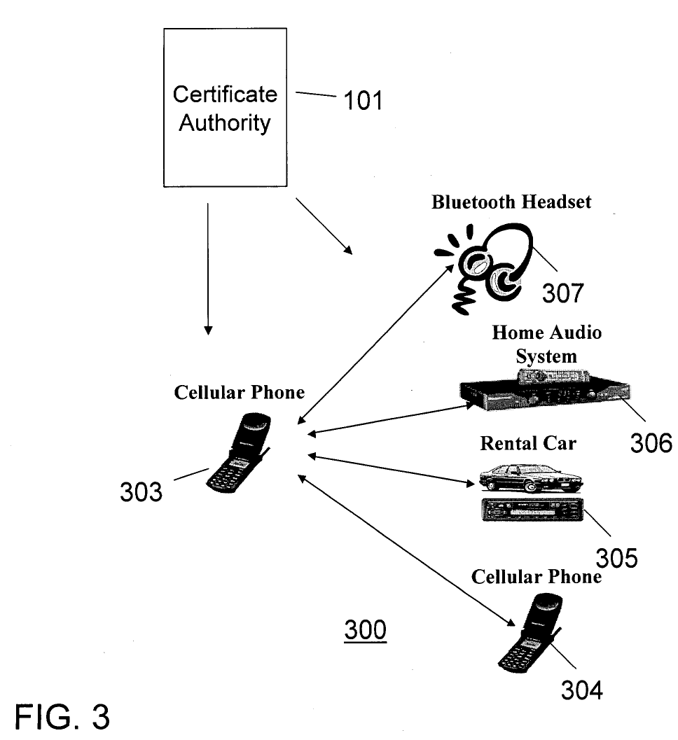

FIG. 3 is a block diagram of a digital-rights management system 300 using a communication system with trust identification capabilities in accordance with the preferred embodiment of the present invention. As shown, DRM system 300 comprises certificate authority 101, electronic device 303, and devices 304-307. In this particular embodiment, electronic device 303 may be a portable device, such as a cellular phone 303, that is capable of storing and managing digital content. For illustration, devices 304-307 may be a wireless (e.g., Bluetooth) headset 307, a home audio system 306, a rental car 305, or another cellular phone 304. Further examples of such devices include Personal Digital Assistants (PDAs), portable music players MP3 players), . . . , etc. In general devices 303 and 304-307 are those capable of storing, transferring and/or receiving digital content. As discussed above, when content is transported between these devices, there is a need to establish the trustworthiness of the receiving device. As such, in the preferred embodiment of the present invention, device 303 maintains a list of trusted and non-trusted devices that is a subset of the master list of trusted and non-trusted devices that exists at the certificate authority 101.

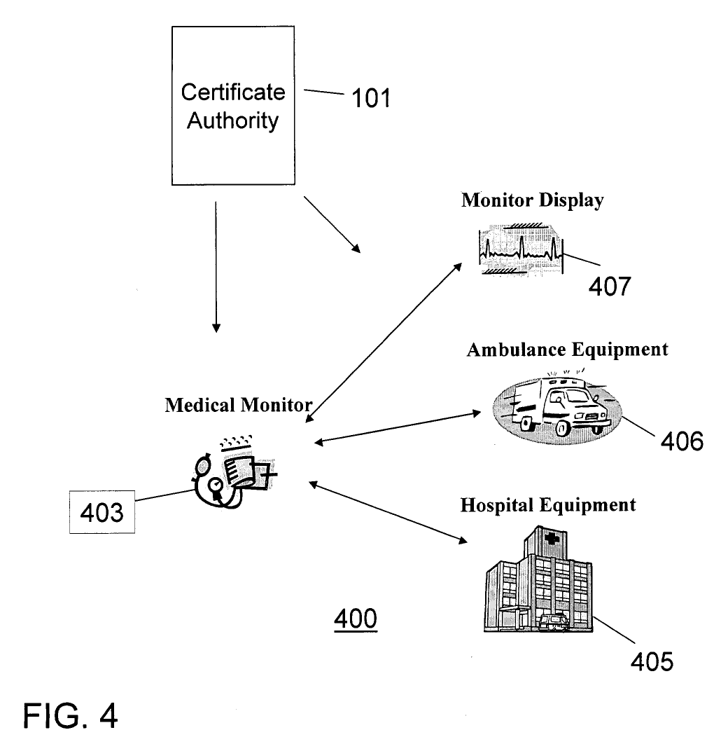

FIG. 4 is a block diagram of a medical monitoring system 400 using a communication system with trust identification capabilities in accordance with the preferred embodiment of the present invention. As shown, medical monitoring system 400 comprises certificate authority 101, electronic device 403, and devices 405-407. In this particular example, electronic device 403 may be a medical monitoring device 403, such as an electrocardiogram-sensing device, that is capable of sending private medical data to devices 405-407. For illustration, devices 405-407 may be a monitor display 407, a piece of ambulance equipment 406, or a piece of hospital equipment 405. In general devices 403 and 405-407 are those capable of sending, recording, and/or receiving private medical data. When private data is transported between these devices, the transmitting device 403 needs to establish the trustworthiness of receiving devices 405-407. As such, in the preferred embodiment of the present invention, device 403 maintains a list of trusted and non-trusted devices that is a subset of the master list of trusted and non-trusted devices that exists at the certificate authority 101.

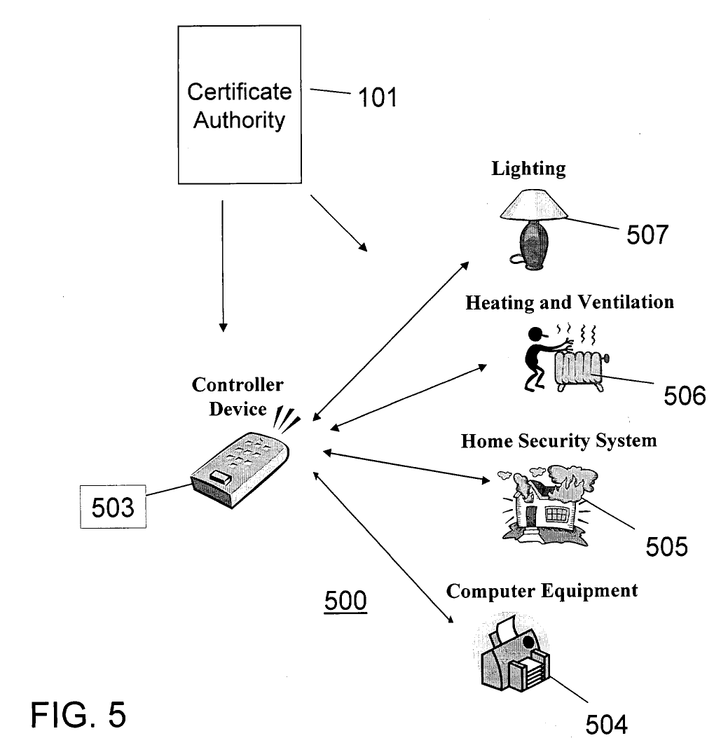

FIG. 5 is a block diagram of a building automation system 500 using a communication system with trust identification capabilities in accordance with the preferred embodiment of the present invention. As shown, building automation system 500 comprises certificate authority 101, electronic device 503, and devices 504-507. In this example embodiment, electronic device 503 may be a controller device 503, such as a remote control, a PDA, a cellular phone, or a notebook computer, that is capable of sending digital commands to devices 504-507. For illustration, device 504-507 may be wireless-controlled lamp 507, heating and ventilation system 506, home security system 505, or other home devices, such as computer equipment 504. In general devices 503-507 are those capable of sending and/or receiving commands. When a command is transported between these devices, the receiving devices 504-507 needs to establish the trustworthiness of the sending device 503. As such, in the preferred embodiment of the present invention, devices 504-507 maintain a list of trusted and non-trusted devices that is a subset of the master list of trusted and non-trusted devices that exists at the certificate authority 101.

One skilled in the art recognizes that the examples in FIG. 3, FIG. 4, and FIG. 5 are for illustrative purposes only. The use the present invention is not limited to these example applications. In general, the present invention can be used whenever a need exists for a method and apparatus for identifying trusted devices.

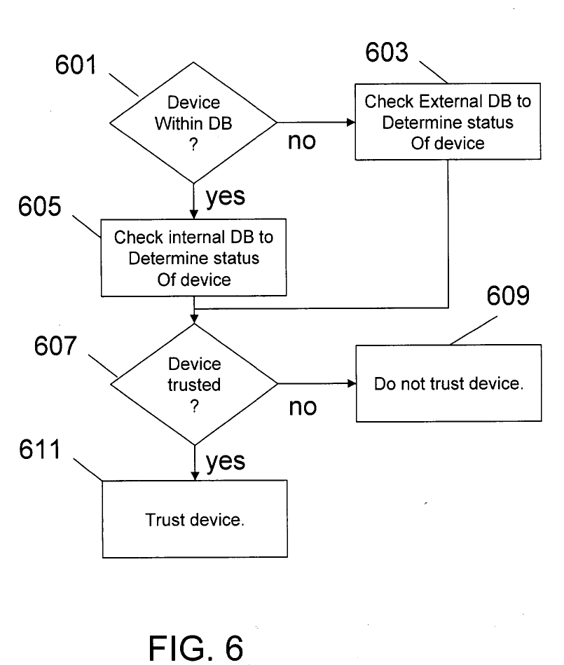

FIG. 6 is a flow chart showing operation of a first electronic device in accordance with the preferred embodiment of the present invention. In the following description, the first electronic device wishes to determine the trustworthiness of a second electronic device. It is assumed that the first electronic device has DRM-protected content (e.g., music, games, etc.), private information (credit card numbers, medical information), or commands that it wishes to send to the second electronic device. Before sending this content, it is required that the second electronic device is either on the internal database of the first electronic device, or that the central authority 101 is contacted to determine the status of the second electronic device. The protocol that the first electronic device uses to judge the trustworthiness of the second electronic device consists of the following steps:

The logic flow begins at step 601 where after determining that a digital command or digital content needs to be transferred from a first device to a second device, logic circuitry 210 determines if the second electronic device exists within cached database 209. If so, the logic flow continues to step 605 where internal cached database 209 is checked to determine the status of the second electronic device. If, at step 601 it is determine that the second electronic device does not exist within its cached database 209, the logic flow continues to step 603 where database 203 is checked to determine the status of the second electronic device.

At step 607 it is determined if the second electronic device is trusted, and if not, the logic flow ends at step 609 where the second electronic device is deemed, untrustworthy. However, if it is determined that the second electronic device is trusted, the logic flow continues to step 611 where the first electronic device deems the second electronic device trustworthy.

At step 611, the first electronic device is assured that second electronic device can be trusted, so, for example, the first electronic device can transfer content (e.g., DRM protected content) to the second electronic device. The technique in which the first electronic device transfers content 217 to the second electronic device can take place using any form of secure communication techniques. In the case of transferring DRM-protected content, the preferred embodiment of the present invention executes the following steps:

1. The first electronic device and the second electronic device establish a secure authenticated channel and establish a session key (e.g., using a protocol such as an authenticated Diffie-Hellman key exchange).

2. The first electronic device verifies that the second, and now authenticated, electronic device is trusted (e.g., using the present invention)

3. The first electronic device uses a “trusted application” to decrypt the DRM protected content.

4. The first electronic device encrypts the content with the session key and streams the encrypted content to the second electronic device.

5. The second electronic device decrypts and renders the content.

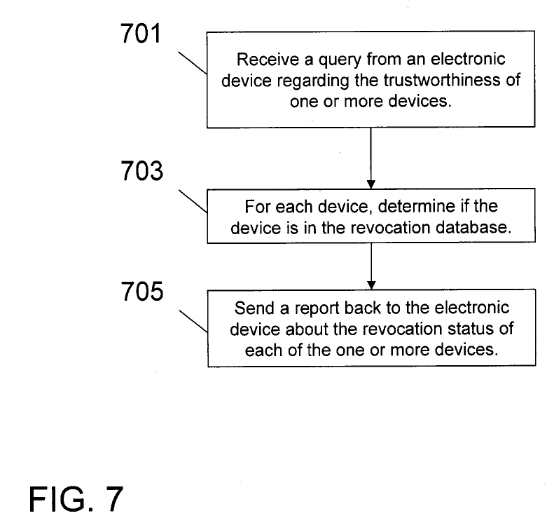

FIG. 7 is a flow chart showing operation of a certificate authority 101 in accordance with the preferred embodiment of the present invention. In the following description, the first electronic device wishes to determine the trustworthiness of one or more devices 103. At step 701, certificate authority 101 receives a query from the first electronic device regarding the trustworthiness of one or more devices 103. At step 703, certificate authority 101 will investigate the trustworthiness of each of the queried devices 103. For each device 103, it will determine if the device 103 is in the revocation database. Finally at step 705, the certificate authority 101 will send a report back to the first electronic device about the revocation status (i.e., the trustworthiness) of each of the one or more devices 103. In the preferred embodiment of the present invention, the query to and the response sent from the certificate authority 101 is communicated over a secure authenticated channel. One skilled in the art of security will realize that there are many protocols for establishing such a secure communication channel. For example, one approach would be to use the Internet standard Transport Layer Security (TLS) protocol.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. An apparatus comprising:
digital content or a digital command;
means for transferring the digital content or the digital command to another device;
a database coupled to the means for transferring, the database comprising only a portion of a second database existing on a remote server, the database comprising a list of trusted and/or non-trusted devices; and
means for limiting the size of the database.

2. The apparatus of claim 1 wherein the means for limiting the size of the database comprises means for limiting the size of the database to those other devices recently encountered.

3. The apparatus of claim 1 wherein the means for limiting the size of the database comprises means for limiting the size of the database to those devices most frequently encountered.

4. The apparatus of claim 1 wherein the means for limiting the size of the database comprises means for choosing those devices designated by the user.

5. The apparatus of claim 1 wherein the remote server comprises a certificate authority or equivalent trusted server within a digital-rights management system.

6. The apparatus of claim 1 wherein the digital content and the database exist within an apparatus taken from the group consisting of a Personal Digital Assistant (PDAs), a cellular telephone, a portable music players, a medical monitoring systems, and a remote control device.

7. The apparatus of claim 1 wherein the digital content and the database exist within an apparatus taken from the group consisting of a wireless-controlled lamp, a heating and ventilation system, and a home security system.

8. A method comprising the steps of:
determining that a digital command or digital content needs to be transferred from a first device to a second device;
determining if the second device exists within an internal database, wherein the internal database comprises only a portion of a second database existing on a remote server, the internal database comprising a list of trusted and/or non-trusted devices; and
transferring the digital command or digital content to the second device based on the determination if the second device exists within the internal database.

9. The method of claim 8 further comprising the step of:
limiting a size of the internal database to devices most recently encountered.

10. The method of claim 8 further comprising the step of:
limiting a size of the internal database to devices most frequently encountered.

11. The method of claim 8 further comprising the step of:
limiting a size of the internal database to devices designated by a user.

12. The method of claim 8 wherein the step of determining if the second device exists within the internal database, comprises the step of determining if the second device exists within the internal database, wherein the internal database comprises only the portion of the second database existing on a certificate authority or equivalent trusted server within a digital-rights management system.

13. The method of claim 8 wherein the step of determining that the digital command or digital content needs to be transferred from the first device to the second device comprises the step of determining that the digital command or digital content needs to be transferred from a device taken from a group consisting of a Personal Digital Assistant (PDAs), a cellular telephone, a portable music players, a medical monitoring systems, and a remote control device.

14. The method of claim 8 wherein the step of determining that the digital command or digital content needs to be transferred from the first device to the second device comprises the step of determining that the digital command or digital content needs to be transferred to a device taken from a group consisting of a wireless-controlled lamp, a heating and ventilation system, a home security system, computer equipment.

15. The method of claim 8 wherein the step of transferring the digital command or digital content to the second device based on the determination that the second device exists within the internal database comprises the steps of:
if the device exists within the internal database:
transferring the digital command or digital content if the device is identified as trusted by the internal database; and
if the device does not exist within the internal database:
accessing an external database and transferring the digital command or digital content if the device is identified as trusted by the external database.

16. The method of claim 8 further comprising the step of:
periodically updating the internal database by accessing a remote database on a periodic basis.

17. The method of claim 16 wherein the step of periodically updating the internal database comprises the step of:
periodically updating the internal database by accessing a remote database and retrieving status information for other devices recently encountered.

18. The method of claim 16 wherein the step of periodically updating the internal database comprises the step of:
periodically updating the internal database by accessing a remote database and retrieving status information for those devices designated by a user.

19. The method of claim 16 wherein the step of periodically updating the internal database comprises the step of:
periodically updating the internal database by accessing a remote database and retrieving status information for those devices most recently encountered.
